(19) United States
(12) Patent Application Publication
(10) Pub. No.: US 2009/0152959 A1
(43) Pub. Date: Jun. 18, 2009

(54) SECONDARY PART OF A LINEAR DRIVE

(75) Inventor: ROLF VOLLMER, Gersfeld (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 12/336,046

(22) Filed: Dec. 16, 2008

(30) Foreign Application Priority Data
Dec. 17, 2007 (EP) 07024404

(51) Int. Cl. H02K 41/03; H02K 57/00

(52) U.S. Cl. 310/12; 310/112

(57) ABSTRACT

A secondary part of a linear drive, in particular of a cylindrical or planar linear drive, has permanent magnets arranged on a soft-magnetic mount in perpendicular relationship to the movement direction of the linear drive. The permanent magnets are curved at least on the surface facing the primary part. The permanent magnets cover each only a predeterminable part of a magnetic pole and have a radial magnetization direction in relation to their outer surface.

### CROSS-REFERENCES TO RELATED APPLICATIONS

This application claims the priority of European Patent Application, Serial No. 07024404, filed Dec. 17, 2007, pursuant to 35 U.S.C. 119(a)-(d), the content of which is incorporated herein by reference in its entirety as if fully set forth herein.

### BACKGROUND OF THE INVENTION

The present invention relates to a secondary part of a linear drive, in particular of a cylindrical or planar linear drive.

Permanent-magnet linear motors are extremely susceptible to force oscillations which occur as a result of relative movements of the primary part and secondary part. The reluctance forces between the permanent magnets and the teeth of the primary part, and the interaction of secondary and primary magnetic fields in the air gap are responsible, inter alia, for the formation of the disturbing force oscillations. The fifth and seventh harmonics of the fundamental of the magnetic air-gap field which is formed in the air gap between the primary part and the secondary part are particularly disturbing in this case.

German Offenlegungsschrift DE 10 2004 045 939 A1 describes a plurality of suppression means in order to suppress such force oscillations in rotating permanent-magnet synchronous machines. In this case, inter alia, a pole coverage of <1 and a stagger of the permanent magnets or an inclination of the permanent magnets, or the inclination of the slots and multiple staggering of permanent magnets of one pole, of the permanent magnets or of the slots are described.

Primary parts without iron have also been in use heretofore, but have the drawback of inadequate utilization of the electrical machine.

It would therefore be desirable and advantageous to provide an improved linear drive to obviate prior art shortcomings and to have only minor force oscillations with comparatively better utilization, while yet simplifying its manufacture and reducing manufacturing costs.

### SUMMARY OF THE INVENTION

According to one aspect of the present invention, a secondary part of a linear drive includes permanent magnets having at least one curved surface which is in confronting relationship to a primary part, each said permanent magnet covering only a predeterminable part of a magnetic pole, wherein the permanent magnets have a magnetization direction in substantially radial relationship to the curved surface.

The use of the permanent magnets, which are curved with respect to the primary part, in conjunction with partial pole curvature of these permanent magnets and in particular with a magnetization direction which is directed essentially radially with respect to the outer surface of the permanent magnets, considerably reduces force oscillations. The measures described above render the air-gap field uniform so that considerably less harmonics are contained, thus resulting in a virtually sinusoidal profile of the air-gap field.

The term “substantially radial magnetization, particularly in the case of curved surfaces of permanent magnets, should be understood as meaning that the field lines of these permanent magnets are not parallel but, in the extreme, run radially with respect to the surface of the permanent magnet, and otherwise are aligned quasi-radially.

According to another advantageous feature of the present invention, the permanent magnets may be arranged on a mount of soft-magnetic material.

According to another advantageous feature of the present invention, the permanent magnets may be arranged on the mount in perpendicular relationship to a movement direction of the linear drive.

According to another advantageous feature of the present invention, the permanent magnets may be configured in the form of a loaf of bread or in the shape of a D, whereby the mount is planar at least in some areas.

The permanent magnets may likewise be formed with two curved surfaces, i.e. in the form of C-shaped permanent magnets, in which case, the mount has a rippled structure so that the permanent magnets can be positioned on ripple peaks of this ripple structure.

When having a C-shaped configuration, the permanent magnets may either be formed with the same magnet thickness or with a magnet thickness which decreases toward the pole edges. This involves however always a substantially radial magnetization direction, but never a parallel magnetization direction of the permanent magnets. The profile of the field lines outside the permanent magnets is not parallel, but has a divergent behavior, in that these field lines diverge from one another.

In a cylindrical linear motor, in particular as part of a combination drive, whose shaft is surrounded by a rotating drive and a linear drive, having a primary part and a secondary part which is formed by permanent magnets which are arranged as ring magnets on a shaft, the polarity is, in particular, alternating when considered over the axial extent of the secondary part. In other words, the ring magnets are aligned alternately with the north pole and south pole toward the primary part. Since ring magnets are relatively difficult to handle, each ring may also be formed from partial shells or partial rings which, when assembled, form a ring magnet with a predeterminable magnetization direction, in particular of the same polarity. The north pole or south pole of the ring magnet or parts of the ring magnet face hereby the air gap of the linear drive.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a perspective view of a basic secondary part according to the present invention;

FIG. 2 is a schematic illustration of one variation of permanent magnets of the secondary part;

FIG. 3 is a schematic illustration of another variation of permanent magnets of the secondary part;

FIG. 4 is a perspective view of a secondary part according to the present invention with C-shaped permanent magnets on a mount;

FIG. 5 is a perspective view of a cylindrical secondary part according to the present invention with ring magnets; and

FIG. 6 is a partially sectional view of a combination drive.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

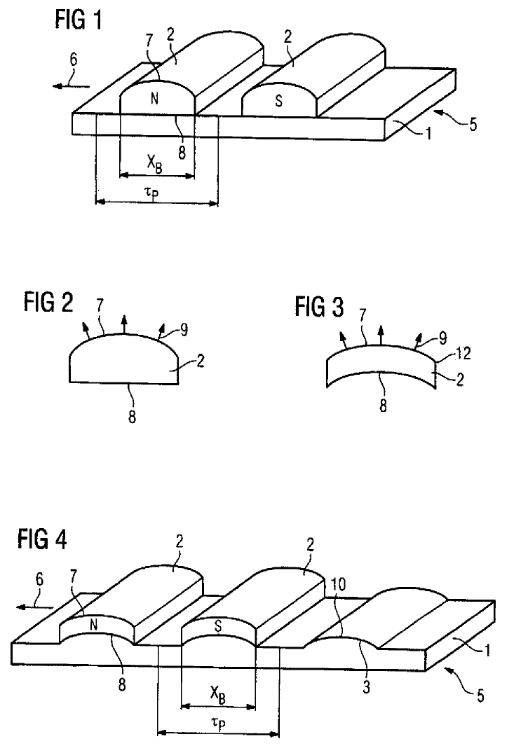

Turning now to the drawing, and in particular to FIG. 1, there is shown a perspective view of a basic secondary part according to the present invention, generally designated by reference numeral 5 and forming part of a planar, i.e., flat, linear drive which is not illustrated in greater detail. The secondary part 5 has a soft-magnetic mount 1 for the magnetic return path and D-shaped permanent magnets 2 which are secured, for example adhesively bonded, on the mount 1 in perpendicular relationship to a movement direction 6 of the linear drive. The permanent magnets 2 cover only a part of the entire magnetic pole τₚ. This partial pole coverage varies in a numerical range from 0.5×τₚ to 0.9×τₚ The permanent magnets 2 have a curved surface 7 facing the air gap, and a planar surface 8 facing the mount 1.

The permanent magnets 2 illustrated in FIG. 1 and the following figures are designated, by way of example, as a north pole and south pole, with only the side of the permanent magnets 2 facing the air gap being designated, although, of course, there are no monopoles, i.e. located on the opposite side of the permanent magnets 2 is the respectively corresponding south pole and/or north pole.

The corresponding opposing poles are thus located on the side of the permanent magnets 2 facing the mount 1 or a shaft, i.e. in the area of the surfaces 8.

As shown in FIG. 2, the D-shaped permanent magnets 2 have only one curved surface 7. The other major surface, the inner surface 8, is planar and can be positioned on a mount 1 which is planar at least in some areas. The magnetization direction 9 of these permanent magnets 2 is radial or quasi-radial with respect to the surface 7.

FIG. 3 shows a permanent magnet 2 which has two curved surfaces 7 and 8, wherein the magnetization direction 9 is likewise arranged radially with respect to the outer surface 7. The inner surface 8 is likewise curved. These C-shaped permanent magnets 2 may be formed with the same or a different radius on the inside and outside, thus resulting in a constant magnet thickness or a magnet thickness which decreases toward the magnet edges 12.

Both the permanent magnets 2 as shown in FIG. 2 and the permanent magnets 2 as shown in FIG. 3 have divergent field lines. In other words, the field lines have a quasi-radial preferred direction, which must necessarily be precisely radial with respect to the surface 7. However, the preferred direction, i.e. the magnetization direction 9, is never parallel.

FIG. 4 shows a mount 1 with a rippled structure 3, wherein C-shaped permanent magnets 2 as shown in FIG. 3 are positioned on the ripple peaks 10. The curvature of the inner surface 8 of the permanent magnets 2 ideally corresponds to the curvature of the ripple peak 8, thus resulting in a good interlocking contact. In this case, a partial pole coverage X_{B} of the permanent magnets 2 is also provided there, in comparison to the pole pitch τₚ as shown in the exemplary embodiment in FIG. 1.

FIG. 5 shows a secondary part 5 of a cylindrical linear motor, which is not illustrated in greater detail and preferably has toroidal coils in its primary part. The secondary part 5 is hereby constructed in the form of a shaft. In this case, as shown in FIGS. 1 to 4, the polarity of the permanent magnets 2, in particular of the ring magnets, alternates and is directed outwards, in the axial direction of the secondary part 5. The ring magnets themselves may be made of a plurality of segmented partial rings for each polarity or ring, thus simplifying assembly. Each segment may hereby, for example, cover an angle range of about 120 degrees of a circumference of the shaft cross section. Three segments would therefore be required in order to produce a complete ring.

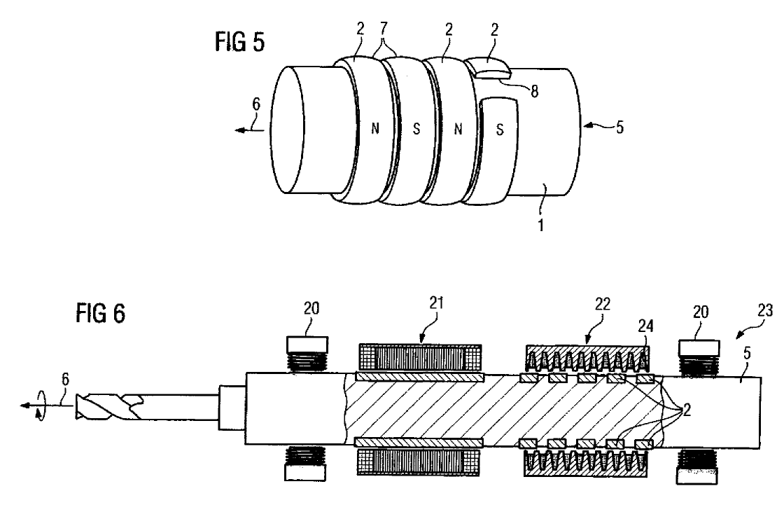

By way of example, illustrated in a basic form, FIG. 6 shows the field of use and the movement degrees of freedom 6 of a secondary part 5 in a combination drive 23 or in other cylindrical linear drives, such as those used in machine tools. The combination drive 23 has at least one rotating drive and one linear drive. In this context, reference is made to the German Offenlegungsschrift DE 10 2004 056 212 A1, the entire specification and drawings of which are expressly incorporated herein by reference.

The shaft 5 is hereby surrounded by these two drives. thereby establishing a direct drive. The rotating drive 21 provides a rotary movement and has permanent magnets which are provided in this area on the shaft 5 and electromagnetically interact with the winding system of the stator, causing rotation. The permanent magnets are not specified in greater detail and in particular also have a quasi-radial magnetization direction.

The cylindrical linear drive 22 is formed by a stator which has toroidal coils 24 which run essentially concentrically around the shaft 5. In this section, the shaft 5 advantageously has permanent magnets 2, in particular ring magnets, with the characteristics as described above, and arranged as described there.

By way of example, a drill is illustrated as a tool of the combination drive 23 although, of course, considerably more complex working processes and movement cycles can also be provided by drives such as these.

In order to allow these movement cycles to be carried out even with the shaft 5 having a relatively large axial movement capability, the permanent magnets of the rotating drive 21 and the ring magnets 2 of the linear drive 22 are distributed on the shaft 5 over an axial section which is greater than the axial length of the respective stator.

The shaft 5 is hereby borne by two bearings 20, which may be in the form of conventional bearings or magnetic bearings.

The force oscillations are considerably reduced by the configuration according to the invention of the permanent magnets with field-line divergence, i.e. a quasi-radial anisotropy (alignment) and/or permanent magnets which have a larger air gap in the direction of the pole edge. This means that the field lines of the permanent magnets never run parallel.

In particular, the arrangement according to the invention can also be applied to the rotating drive 21 of a combination drive in that, inter alia, permanent magnets with a radial, in particular quasi-radial, preferred direction, i.e. anisotropy or a magnetization direction (9), are also used there. A sinusoidal profile of the air-gap field is also desirable there.

The advantage according to the invention occurs in particular in the case of short stators of the cylindrical linear drive 22 which, for example, have only three toroidal coils 24 arranged axially one behind the other.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A secondary part of a linear drive, comprising permanent magnets having at least one curved surface which is in confronting relationship to a primary part, each said permanent magnet covering only a predeterminable part of a magnetic pole, wherein the permanent magnets have a magnetization direction in substantially radial relationship to the curved surface:

2. The secondary part of claim 1, further comprising a mount made of soft-magnetic material and supporting the permanent magnets.

3. The secondary part of claim 2, wherein the permanent magnets are arranged on the mount in perpendicular relationship to a movement direction of the linear drive.

4. The secondary part of claim 1, wherein the linear drive is a cylindrical or planar linear drive.

5. The secondary part of claim 2, wherein the mount is planar, said permanent magnets being configured in the form of a loaf of bread or in the shape of a D.

6. The secondary part of claim 2, wherein the mount has a rippled structure which defines peaks and extends perpendicular to a movement direction of the linear drive, said permanent magnets being arranged on the peaks and configured in the shape of a C with two curved surfaces.

7. The secondary part of claim 6, wherein the permanent magnets have a same radial magnet thickness over their pole coverage.

8. The secondary part of claim 6, wherein the permanent magnets have each pole edges and a magnet thickness which decreases toward the pole edges.

9. The secondary part of claim 2, wherein the mount has a cylindrical configuration, wherein the permanent magnets of one magnetic pole are constructed in the form of a ring.

10. The secondary part of claim 9, wherein neighboring ring-shaped permanent magnets have alternating polarity.

11. The secondary part of claim 9, wherein the ring is made of partial rings arranged adjacent to one another in a circumferential direction.

12. The secondary part of claim 11, wherein the partial rings have one or alternating polarity.

13. The secondary part of claim 11, wherein each of the partial rings extends at an angle range of about 120°.

14. The secondary part of claim 1, wherein the primary part is formed from toroidal coils arranged in slots of the primary part.

15. A combination direct drive, comprising:
a cylindrical linear drive having a primary part;
a shaft forming a secondary part of the linear drive and including permanent magnets having at least one curved surface which is in confronting relationship to the primary part, each said permanent magnet covering only a predeterminable part of a magnetic pole, wherein the permanent magnets have a magnetization direction in substantially radial relationship to the curved side;
a rotating drive having a primary part and disposed in surrounding relationship to the shaft positioned next to the linear drive and forming a secondary part of the rotating drive.

16. The combination direct drive of claim 15, wherein the permanent magnets of the secondary part of the linear drive are arranged in spaced-apart relationship along an axial length which is greater than an axial length of the primary part of the linear drive.

17. The combination direct drive of claim 15, wherein the secondary part of the rotating drive has permanent magnets defined by an axial length which is greater than an axial length of the primary part of the rotating drive.
